(19) United States
(12) Patent Application Publication
(10) Pub. No.: US 2013/0043234 A1
(43) Pub. Date: Feb. 21, 2013

(54) HEATING DEVICE AND TEMPERATURE CONTROL DEVICE

(71) Applicants: Ming-Wei TSAI, New Taipei City (TW); Min-Lang Huang, Taipei City (TW)

(72) Inventors: Ming-Wei TSAI, New Taipei City (TW); Min-Lang Huang, Taipei City (TW)

(21) Appl. No.: 13/212,628

(22) Filed: Aug. 18, 2011

(51) Int. Cl. H05B 3/02; H05B 1/02; H05B 3/20

(52) U.S. Cl. 219/220; 219/538; 219/544; 219/494

(57) ABSTRACT

A heating device and a temperature control device are provided. The heating device includes a heating element, and a heat conducting film disposed on the surface of the heating element, wherein the heat conducting film has a surface area that is larger than the contact area between the heat conducting film and the heating element. The heat conducting film is used for uniformly conducting heat generated by the heating element. Therefore, the existing non-uniform heating and slow heat dissipation problems for the heating element having a large surface area can be solved. Furthermore, because the metallic heat conducting film has good heat conduction, the heat can be quickly spread over a larger area to prevent localized overheating and damage to the heating element itself or the electrical product.

### BACKGROUND OF THE INVENTION

1. Field of the Invention

The present invention relates to a heating equipment, and more particularly to a heating device and a temperature control device.

2. The Prior Arts

Nowadays, the heating elements usually include heating filaments, heating plates, heating disks, and heating tubes. However, when a large area is heated by using the heating filaments or heating plates, the heat distribution in such a large area will be non-uniform. Moreover, when the heating device with the metallic plate for conducting heat is used, heating and heat dissipating are slow.

Conventionally, in the first case, the heating devices can have heating function but without temperature control, but for these heating devices, heating is slow, the heating temperature will be continuously raised, and electricity consumption is high. Conventionally, in the second case, the heating devices can also have heating with temperature control function, but for these heating devices, the temperature control is usually not accurate. However, if the heating devices have accurate temperature control function, they are very expensive. Furthermore, the current heating products will remain in the “on” state after they are switched on, which are power-consuming and not safe in use.

Conventionally, the temperature control switches are usually used in the temperature control element. When the heating device is overheated, the electrical power for the heating device will be turned off by the temperature control switch, and when the heating device is needed to be heated, the electrical power for the heating device will be turned on by the temperature control switch. Consequently, the heating temperature becomes not stable for the heating device, and thereby the manual adjustment is required, which will cause inconvenience and inaccuracy.

### SUMMARY OF THE INVENTION

An objective of the present invention is to provide a heating device that can conduct heat uniformly and dissipate heat efficiently, and that is safe in use.

Another objective of the present invention is to provide a temperature control device that can be accurately controlled, convenient to operate, and safe in use.

The heating device of the present invention comprises a heating element; and a heat conducting film disposed on a surface of the heating element, wherein the heat conducting film has a surface area that is larger than the contact area between the heat conducting film and the heating element. The heat conducting film is a metallic film, and has a round shape, a triangular shape, or a polygonal shape.

The temperature control device of the present invention comprises a power supply module, a controller chip, a temperature sensor module, a power supply control module, a pressure switch module, and a heating device, wherein an output end of the power supply module is connected with an input end of the power supply control module; input ends of the controller chip are connected respectively to an output end of the power supply module and an output end of the temperature sensor module; an output end of the controller chip is connected with an input end of the power supply control module and an input end of the pressure switch module; an output end of the pressure switch module is connected with an input end of the heating device; and an output end of the heating device is connected with an input end of the temperature sensor module.

Heat generated by the heating element can be uniformly conducted by the heat conducting film. Therefore, the existing non-uniform heating and slow heat dissipation problems for the heating element having a large surface area can be solved. Furthermore, because the metallic heat conducting film has good heat conduction, the heat can be quickly spread over a larger area to prevent localized overheating and damage to the heating element itself or the electrical product. Furthermore, the heating device of the present invention can uniformly dissipate heat so that it can be applied to many different fields

In the present invention, the heating process of the heating element is controlled by a controller chip that applies a variation of voltages to the heating element, rather than by a simple switching. Consequently, the temperature control can be more accurate. The pressure switch module is used in the present invention to improve the safety of the circuit. The desired temperature range can be set by the controller chip, and the temperature control device can provide automatic heating and cooling in the desired temperature range, and thereby the temperature control is well ensured.

The heating device and temperature control device of present invention can be applied to far-infrared heating blankets, warming utensils, electric blankets, heating massage pillows, heating straps for motorcycle handles, heater for vehicle rearview mirror, far-infrared heating helmets, outdoor heating seat cushions, food warming bags, heaters for vehicle tires, heating jackets, heaters for massagers, heating pads, etc. In the present invention, the heating and temperature maintaining can be achieved effectively, and thereby the problems of the prior art can be overcome.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a heating device according to one embodiment of the present invention;

FIG. 2 is a block diagram of a temperature control device according to one embodiment of the present invention;

FIG. 3 is a circuit diagram of the temperature control device according to one embodiment of the present invention;

FIG. 4 is a schematic view showing a pressure switch module according to one embodiment of the present invention; and

FIG. 5 is a schematic view showing a heating element according to one embodiment of the present invention.

### DETAILED DESCRIPTION OF THE PREFERRED EMBODIMENTS

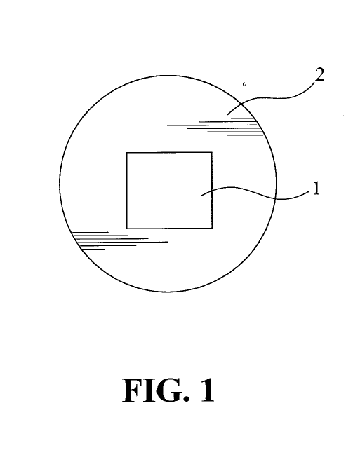

FIG. 1 is a schematic view showing a heating device according to one embodiment of the present invention. The heating device comprises a heating element 1, and a heat conducting film 2 disposed on the surface of the heating element 1. The heat conducting film 2 has a surface area that is larger than the contact area between the heat conducting film 2 and the heating element 1. The heating element is selected from at least one of the group consisting of PTC heating elements, ceramic electrothermal boards, silicon carbide tube heating elements, metal heating elements, carbon crystal heating elements, graphite heating elements, quartz heating elements, molybdenum disilicide heating elements, electrothermal filaments, thick film stencil, carbon fiber quartz heating elements, nano electrothermal film heating plates, and superconductor heating elements. The heat conducting film 2 is a metallic film, such as aluminum foil film having good heat conducting properties. The metallic film can have a circular, triangular, polygonal, or other shape in order to fit the shapes of different devices.

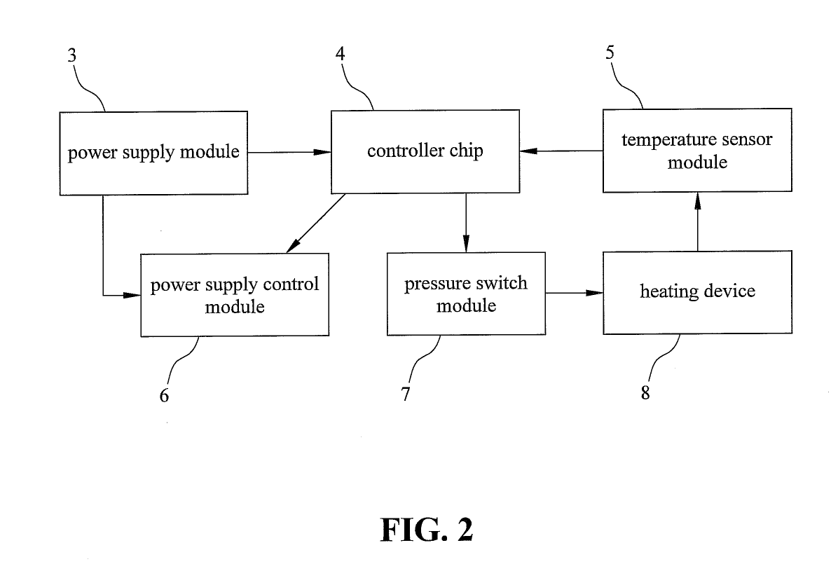

FIG. 2 is a block diagram of a temperature control device according to one embodiment of the present invention. As shown in FIG. 2, a temperature control device of the present invention comprises a power supply module 3, a controller chip 4, a temperature sensor module 5, a power supply control module 6, a pressure switch module 7, and a heating device 8. An output end of the power supply module 3 is connected with an input end of the power supply control module 6. The two input ends of the controller chip 4 are connected respectively to the output end of the power supply module 3 and the output end of the temperature sensor module 5. The output end of the controller chip 4 is connected with the input end of the power supply control module 6 and the input end of the pressure switch module 7. The output end of the pressure switch module 7 is connected with the input end of the heating device 8. The output end of the heating device 8 is connected with the input end of the temperature sensor module 5.

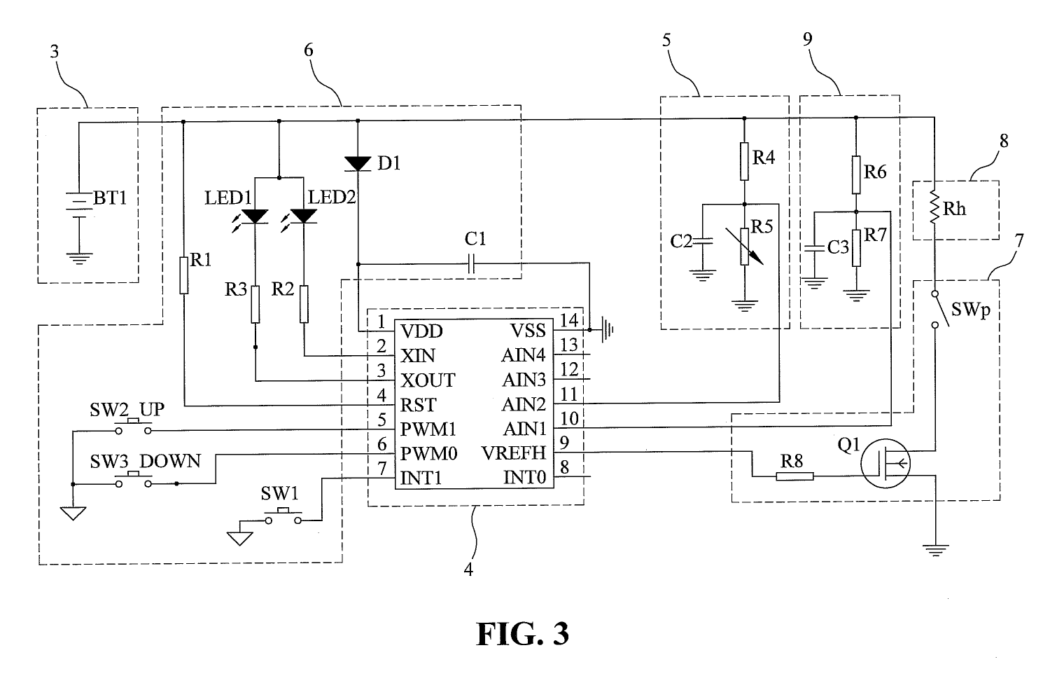

FIG. 3 is a circuit diagram of the temperature control device according to one embodiment of the present invention. The power supply module 3 is a power source BT1. The controller chip 4 has pins 1 to 14. The power supply control module 6 comprises the first resistor R1, the second resistor R2, the third resistor R3, the first capacitor C1, the first light-emitting diode LED1, the second light-emitting diode LED2, the diode D1, the first switch SW1, the second switch SW2, and the third switch SW3. The temperature sensor module 5 comprises the fourth resistor R4, the fifth resistor R5, and the second capacitor C2. The heating device 8 comprises the heating element Rh. The pressure switch module 7 comprises a pressure switch SWp, a transistor Q1, and the eighth resistor R8. The positive electrode of the power source BT1 is connected respectively to one end of the heating element Rh, one end of the first resistor R1, one end of the diode D1, one end of the first light-emitting diode LED1, one end of the second light-emitting diode LED2, and one end of the fourth resistor R4. The negative electrode of the power source BT1 is connected to the ground. Another end of the first resistor R1 is connected to pin 4, RST of the controller chip 4. The first light-emitting diode LED1 is connected to one end of the third resistor R3. Another end of the third resistor R3 is connected to pin 3, XOUT of the controller chip 4. The second light-emitting diode LED2 is connected to one end of the second resistor R2. Another end of the second resistor R2 is connected to pin 2, XIN of the controller chip 4. The negative electrode of the diode D1 and one end of the first capacitor C1 are connected respectively to pin 1, VDD of the controller chip 4. Another end of the first capacitor C1 and pin 14, VSS of the controller chip 4 are connected to the ground. Pin 7, INT1 of the controller chip 4 is connected to one end of the first switch SW1. Another end of the first switch SW1 is connected to a low potential terminal. Pin 6, PWM0 of the controller chip 4 is connected to one end of the third switch SW3, and pin 5, PWM1 of the controller chip 4 is connected to one end of the second switch SW2. Another end of the third switch SW3 and another end of the second switch SW2 are connected to a low potential terminal. Another end of the fourth resistor R4, one end of the fifth resistor R5, and one end of the second capacitor C2 are connected respectively to pin 11, AIN2 of the controller chip 4. Another end of the fifth resistor R5 and another end of the second capacitor C2 are connected to the ground. Another end of the heating element Rh is connected to one end of the pressure switch SWp. Another end of the pressure switch SWp is connected to the drain of the transistor Q1. The gate of the transistor Q1 is connected to one end of the eighth resistor R8, and the source of the transistor Q1 is connected to the ground. Another end of the eighth resistor R8 is connected to pin 9, VREFH of the controller chip 4.

The temperature control device further comprises a power source detection module 9. The input end of the power source detection module 9 is connected with the output end of the power supply module 3, and the output end of the power source detection module 9 is connected with the input end of the controller chip 4. The power source detection module 9 comprises the sixth resistor R6, the seventh resistor R7, and the third capacitor C3. One end of the sixth resistor R6 is connected to the positive electrode of the power source BT1. Another end of the sixth resistor R6, one end of the seventh resistor R7, and one end of the third capacitor C3 are connected respectively to pin 10, AIN1 of the controller chip 4. Another end of the seventh resistor R7 and another end of the third capacitor C3 are connected to the ground.

The first resistor R1 has a resistance value of 100 K\tilde{Ω}. The second resistor R2 has a resistance value of 5.1 KΩ (510R). The third resistor R3 has a resistance value of 5.1 KΩ (510R). The fourth resistor R4 has a resistance value of 100 KΩ. The fifth resistor is a negative temperature coefficient (NTC) thermistor of 100 KΩ. The sixth resistor has a resistance value of 200 KΩ. The seventh resistor has a resistance value of 100 KΩ. The eighth resistor has a resistance value of 2 KΩ. The first capacitor has a capacitance value of 0.1 μF (104), the second capacitor has a capacitance value of 0.1 μF (104), and the third capacitor has a capacitance value of 0.001 μF (102). The controller chip 4 can be a model SN8P2711P/S controller chip. The diode D1 can be a model IN4148 diode. The transistor Q1 can be a model ME2312 transistor.

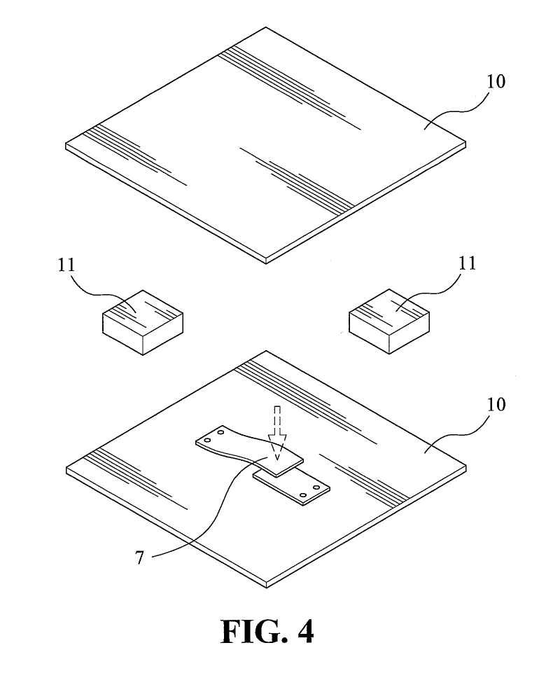

FIG. 4 is a schematic view showing a pressure switch module according to one embodiment of the present invention. Referring to FIG. 4, the pressure switch module 7 of the present invention is disposed between two fireproof insulation boards 10, and the two fireproof insulation boards 10 are separated by a space using at least two elastic sponges 11.

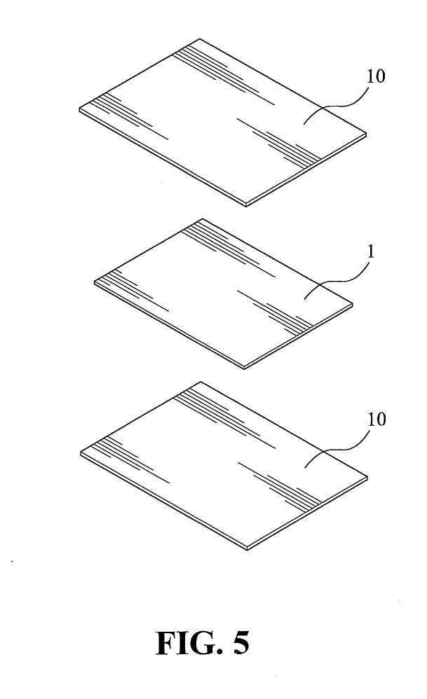

FIG. 5 is a schematic view showing a heating element according to one embodiment of the present invention. Referring to FIG. 5, the heating element 1 is disposed between two fireproof insulation boards 10 so that the heating element 1 can be fireproof.

The fireproof insulation boards used in the present invention are selected from at least one of the group consisting of silicone coated fiberglass fabric, basalt fiber fireproof fabric, acrylic fabric, 100% cotton flame retardant fabric, CVC flame retardant fabric, Cotton/Nylon flame retardant fabric, NOMEX flame retardant fabric, SM flame retardant fabric, blue fiber flame retardant fabric, aluminum foil fiberglass flame retardant fabric, coating flame retardant fabric, high silica fabric, silicon-titanium fabric, fire resistant Eva foam, and fire resistant sponge.

The heat conducting film 2 dissipates uniformly heat produced from the heating element 1. As a result, existing problems related to non-uniform heat emission and sensing of large surface areas, and slow heating and dissipation can be overcome. Point heating is replaced with surface heating, so that uniform heating can be obtained for large surface areas. Furthermore, the metallic heat conducting film has good conduction properties, and can dissipate heat quickly to prevent local overheating that may damage the electric appliance or the heating element 1. In addition, uniform heat dissipation can allow the heating device to be suitable for a wider range of application.

The present invention uses a controller chip that applies a variation of voltages to control heating of the heating element, rather than simple switching control. Therefore, the temperature control can be more accurate and power-saving. The addition of a pressure switch also allows the circuit to be safer and energy-saving. The controller chip can set the desired range of temperature, and the temperature control device can provide automatic heating and cooling in the temperature range, so that a constant temperature can be kept continuously.

For example, the present invention can be used in far-infrared heating blankets, warming utensils, electric blankets, heating massage pillows, heating straps for motorcycle handles, heater for vehicle rearview mirror, far-infrared heating helmets, outdoor heating seat cushions, food warming bags, heaters for vehicle tires, heating jackets, heaters for massagers, heating pads, etc. The heating can be performed effectively by setting the desired temperature, which can overcome the problems of the prior art.

The foregoing description is intended to only provide illustrative ways of implementing the present invention, and should not be construed as limitations to the scope of the present invention. While the foregoing is directed to embodiments of the present invention, other and further embodiments of the invention may thus be devised without departing from the basic scope thereof, and the scope thereof is determined by the claims that follow.

What is claimed is:

1. A heating device comprising:
a heating element; and
a heat conducting film disposed on a surface of the heating element.

2. The heating device of claim 1, wherein the heat conducting film has a surface area that is larger than a contact area between the heat conducting film and the heating element.

3. The heating device of claim 2, wherein the heat conducting film is a metallic film, and the heating element is selected from at least one of the group consisting of PTC heating elements, ceramic electrothermal boards, silicon carbide tube heating elements, metal heating elements, carbon crystal heating elements, graphite heating elements, quartz heating elements, molybdenum disilicide heating elements, electrothermal filaments, thick film stencil, carbon fiber quartz heating elements, nano electrothermal film heating plates, and superconductor heating elements.

4. The heating device of claim 3, wherein the metallic film has a round shape, a triangular shape, or a polygonal shape.

5. The heating device of claim 1, wherein the heating element is disposed between two fireproof insulation boards.

6. The heating device of claim 5, wherein the two fireproof insulation boards are selected from at least one of the group consisting of silicone coated fiberglass fabric, basalt fiber fireproof fabric, acrylic fabric, 100% cotton flame retardant fabric, CVC flame retardant fabric, Cotton/Nylon flame retardant fabric, NOMEX flame retardant fabric, SM flame retardant fabric, blue fiber flame retardant fabric, aluminum foil fiberglass flame retardant fabric, coating flame retardant fabric, high silica fabric, silicon-titanium fabric, fire resistant Eva foam, and fire resistant sponge.

7. A temperature control device used in a heating device, comprising:
a power supply module, a controller chip, a temperature sensor module, a power supply control module, a pressure switch module, and a heating device, wherein an output end of the power supply module is connected with an input end of the power supply control module; input ends of the controller chip are connected respectively to an output end of the power supply module and an output end of the temperature sensor module; an output end of the controller chip is connected with an input end of the power supply control module and an input end of the pressure switch module; an output end of the pressure switch module is connected with an input end of the heating device; and an output end of the heating device is connected with an input end of the temperature sensor module.

8. The temperature control device of claim 7, wherein the power supply module is a power source; the controller chip has pins 1 to 14; the power supply control module comprises a first resistor, a second resistor, a third resistor, a first capacitor, a first light-emitting diode, a second light-emitting diode, a diode, a first switch, a second switch, and a third switch; the temperature sensor module comprises a fourth resistor, a fifth resistor, and a second capacitor; the heating device comprises a heating element; and the pressure switch module comprises a pressure switch, a transistor, and a eighth resistor; and wherein, a positive electrode of the power source is connected respectively to one end of the heating element, one end of the first resistor, one end of the diode, one end of the first light-emitting diode, one end of the second light-emitting diode, and one end of the fourth resistor; a negative electrode of the power source is connected to the ground; another end of the first resistor is connected to the pin 4 of the controller chip; the first light-emitting diode is connected to one end of the third resistor; an another end of the third resistor is connected to the pin 3 of the controller chip; the second light-emitting diode is connected to one end of the second resistor; an another end of the second resistor is connected to the pin 2 of the controller chip; a negative electrode of the diode and one end of the first capacitor are connected respectively to the pin 1 of the controller chip; an another end of the first capacitor and the pin 14 of the controller chip are connected to the ground; the pin 7 of the controller chip is connected to one end of the first switch; an another end of the first switch is connected to a low potential terminal; the pin 6 of the controller chip is connected to one end of the third switch, and the pin 5 of the controller chip is connected to one end of the second switch; an another end of the third switch and an another end of the second switch are connected to a low potential terminal; an another end of the fourth resistor, one end of the fifth resistor, and one end of the second capacitor are connected respectively to the pin 11 of the controller chip; an another end of the fifth resistor and an another end of the second capacitor are connected to the ground; an another end of the heating element is connected to one end of the pressure switch; an another end of the pressure switch is connected to a drain of the transistor, a gate of the transistor is connected to one end of the eighth resistor, and a source of the transistor is connected to the ground; and another end of the eighth resistor is connected to the pin 9 of the controller chip.

9. The temperature control device of claim 8, further comprising a power source detection module, wherein an input end of the power source detection module is connected with an output end of the power supply module, and an output end of the power source detection module is connected with an input end of the controller chip.

10. The temperature control device of claim 9, wherein the power source detection module comprises a sixth resistor, a seventh resistor, and a third capacitor, wherein an end of the sixth resistor is connected to a positive electrode of the power source; an another end of the sixth resistor, an end of the seventh resistor, and an end of the third capacitor are connected respectively to the pin 10 of the controller chip; and an another end of the seventh resistor and an another end of the third capacitor are connected to a ground.

11. The temperature control device of claim 8, wherein the first resistor has a resistance value of 100 KΩ, the second resistor has a resistance value of 5.1 KΩ, the third resistor has a resistance value of 5.1 KΩ, the fourth resistor has a resistance value of 100 KΩ the fifth resistor is a negative temperature coefficient thermistor of 100 KΩ, the eighth resistor has a resistance value of 2 KΩ, the first capacitor has a capacitance value of 0.1 μF, and the second capacitor has a capacitance value of 0.1 μF.

12. The temperature control device of claim 10, wherein the sixth resistor has a resistance value of 200 KΩ, the seventh resistor has a resistance value of 100 KΩ, and the third capacitor has a capacitance value of 0.001 μF.

13. The temperature control device of claim 8, wherein the heat conducting film is a metallic film, and the heating element is selected from at least one of the group consisting of PTC heating elements, ceramic electrothermal boards, silicon carbide tube heating elements, metal heating elements, carbon crystal heating elements, graphite heating elements, quartz heating elements, molybdenum disilicide heating elements, electrothermal filaments, thick film stencil, carbon fiber quartz heating elements, nano electrothermal film heating plates, and superconductor heating elements.

14. The temperature control device of claim 8, wherein the temperature control device is disposed between two fireproof insulation boards.

15. The temperature control device of claim 7, wherein the pressure switch module is disposed between two fireproof insulation boards, and the two fireproof insulation boards are separated by a space using at least two elastic sponges.

16. The temperature control device of claim 14, wherein the two fireproof insulation boards are selected from at least one of the group consisting of silicone coated fiberglass fabric, basalt fiber fireproof fabric, acrylic fabric, 100% cotton flame retardant fabric, CVC flame retardant fabric, Cotton/Nylon flame retardant fabric, NOMEX flame retardant fabric, SM flame retardant fabric, blue fiber flame retardant fabric, aluminum foil fiberglass flame retardant fabric, coating flame retardant fabric, high silica fabric, silicon-titanium fabric, fire resistant Eva foam, and fire resistant sponge.

17. The temperature control device of claim 15, wherein the two fireproof insulation boards are selected from at least one of the group consisting of silicone coated fiberglass fabric, basalt fiber fireproof fabric, acrylic fabric, 100% cotton flame retardant fabric, CVC flame retardant fabric, Cotton/Nylon flame retardant fabric, NOMEX flame retardant fabric, SM flame retardant fabric, blue fiber flame retardant fabric, aluminum foil fiberglass flame retardant fabric, coating flame retardant fabric, high silica fabric, silicon-titanium fabric, fire resistant Eva foam, and fire resistant sponge.
